(19) United States
(12) Patent Application Publication
(10) Pub. No.: US 2009/0096664 A1
(43) Pub. Date: Apr. 16, 2009

(54) Method, Apparatus and Computer Program Product for Providing Stabilization During a Tracking Operation

(75) Inventors: Carlton William Carroll, Barboursville, VA (US); Daniel Morgan Dempsey, Wingina, VA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Northrop Grumman Systems Corporation

(21) Appl. No.: 11/870,003

(22) Filed: Oct. 10, 2007

(51) Int. Cl. G01S 13/00

(52) U.S. Cl. 342/147

(57) ABSTRACT

An apparatus for providing stabilization during a tracking operation may include a processing element configured to define an inertial pointing vector relative to a point of interest, receive tracking information related to the point of interest, and determine compensation of the inertial pointing vector based on the received tracking information and motion of a platform conducting the tracking operation.

### FIELD OF THE INVENTION

Embodiments of the present invention relate generally to tracking operations, and more particularly, to providing a method, apparatus and computer program product for providing stabilization during a tracking operation.

### BACKGROUND OF THE INVENTION

The tracking of objects has long been an endeavor that has been undertaken in numerous environments. For example, air and seaborne vessels or objects, land based vehicles or objects, meteorological objects, objects in space, and numerous other objects have been tracked for various purposes. Accordingly, sophisticated devices have been developed to assist in the tracking of such objects. Some of the sophisticated devices that have been developed use video images, radar, or other mechanisms to provide tracking data used for tracking objects of interest. In this regard, for example, a typical tracking problem may include operations of acquiring an object of interest by some mechanism (e.g., within an image, by receiving a radio frequency, sonar or radar return, etc.) and maintaining track on the object of interest using further tracking data.

With the improved technology available in today's world, target acquisition, and particularly the resolution associated with acquiring information about a target, have been vastly increased over previously known capabilities. For example, optical devices can zoom in on an object to provide a very detailed, albeit very narrow, field of view. Additionally, sonar and radar devices can generate very narrow beams in order to provide extremely accurate information regarding the bearing to an object of interest. However, in cases such as the examples above, the very narrow nature of the tracking mechanism employed, though a great advantage when locked onto a particular object, may present problems with regard to maintaining track on an object. In this regard, for example, if an object within an image is being tracked and the image provides a very narrow field of view, motion of a vessel employing a tracking device or instability in the platform supporting the tracking device may lead to the object being placed outside the narrow field of view. Accordingly, track may be lost on the object and time and effort may be required to regain track on the object. In certain environments, large amounts of time may be expended in cyclic reacquiring and tracking operations.

Techniques have been developed to enable a tracking device to compensate for the motion of the vessel by placing gyros and/or accelerometers on the tracking device being compensated. However, the technique is very expensive since each tracking device (and there may be many) would typically require its own set of gyros and accelerometers. Additionally, motion inserted by user controls may also be detected by the compensation technique resulting in undesired attempts at compensation at certain times.

Accordingly, it may be desirable to use a mechanism for use in tracking operations that may overcome at least some of the deficiencies described above.

### BRIEF SUMMARY OF THE INVENTION

Embodiments of the present invention provide a method, computer program product and apparatus for providing stabilization during a tracking operation. In particular, embodiments of the present invention provide a system configured to simultaneously compensate multiple systems using external sensors for stabilization and target tracking. In this regard, embodiments of the present invention may utilize motion sensors associated with a platform employing a tracking device in order to determine motion compensation that is translated to account for motion of the tracking device and the motion of the platform.

In one exemplary embodiment, a method for providing stabilization during a tracking operation is provided. The method may include defining an inertial pointing vector relative to a point of interest, receiving tracking information related to the point of interest, and determining compensation of the inertial pointing vector based on the received tracking information and motion of a platform conducting the tracking operation.

In another exemplary embodiment, a computer program product for providing stabilization during a tracking operation is provided. The computer program product includes at least one computer-readable storage medium having computer-readable program code portions stored therein. The computer-readable program code includes multiple executable portions. The first executable portion is for defining an inertial pointing vector relative to a point of interest. The second executable portion is for receiving tracking information related to the point of interest. The third executable portion is for determining compensation of the inertial pointing vector based on the received tracking information and motion of a platform conducting the tracking operation.

In another exemplary embodiment, an apparatus for providing stabilization during a tracking operation is provided. The apparatus may include a processing element configured to define an inertial pointing vector relative to a point of interest, to receive tracking information related to the point of interest, and to determine compensation of the inertial pointing vector based on the received tracking information and motion of a platform conducting the tracking operation.

Embodiments of the invention may provide an improved ability to track objects or points of interest without placing sensor equipment on each tracking device. As a result, system capabilities may be enhanced without substantially increasing system cost, weight, and maintenance requirements.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram illustrating an exemplary system for providing stabilization during a tracking operation according to an exemplary embodiment of the present invention;

FIG. 2 illustrates a diagram of reference axes used for determining platform motion according to an exemplary embodiment of the present invention;

FIG. 3 illustrates an example of inputting camera coordinates relative to the center of rotation of the platform 36 in order to enable platform motion translation according to an exemplary embodiment of the present invention;

FIG. 4 illustrates a diagram of a yaw rotation according to an exemplary embodiment of the present invention;

FIG. 5 illustrates a diagram of a pitch rotation according to an exemplary embodiment of the present invention;

FIG. 6 illustrates a diagram of a roll rotation according to an exemplary embodiment of the present invention;

FIG. 7 is a diagram illustrating a pan and tilt angle determination according to an exemplary embodiment of the present invention;

FIG. 8 is a diagram illustrating an offset target according to an exemplary embodiment; and

FIG. 9 is a flowchart of a method for providing stabilization during a tracking operation according to an exemplary embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

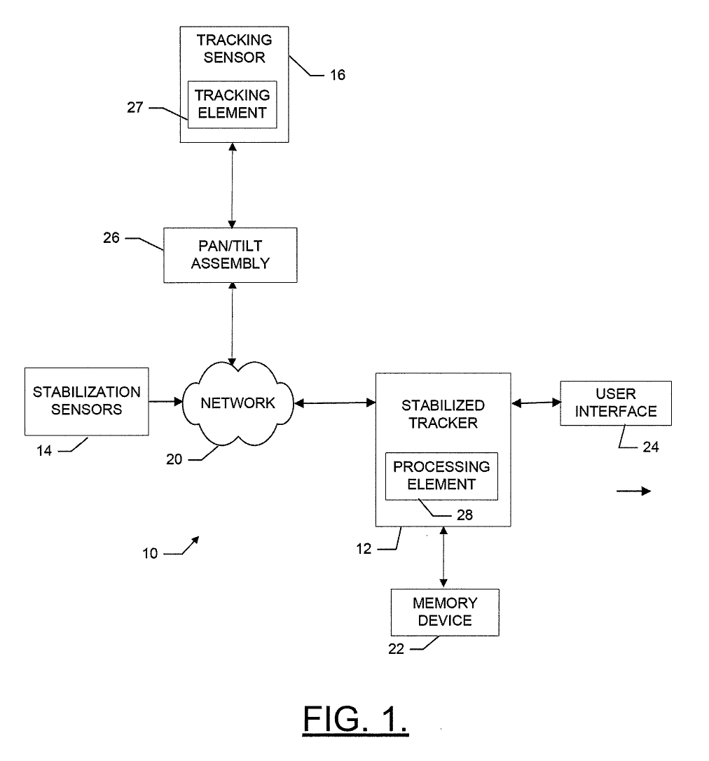

FIG. 1 is a basic block diagram illustrating a system 10 that may benefit from exemplary embodiments of the present invention. As shown and described herein, the system 10 could be part of a marine system, a land-based tracking system, an air-based tracking system or the like. As shown, the system 10 may include a number of different devices or elements, each of which may comprise any device or means embodied in either hardware, software, or a combination of hardware and software configured to perform one or more functions, including those attributed to the respective devices or elements as described herein. For example, the system 10 may include a stabilized tracker 12, a stabilization sensor (e.g., gyros and accelerometers) 14, a tracking sensor (e.g., a camera) 16 and/or numerous other peripheral devices or elements. One or more of the devices or elements of the system 10 may be configured to communicate with one or more of the other devices or elements to process and/or display data, information or the like (“data,” “information,” or the like generally referred to herein as “data”) from one or more of the devices or elements. The devices or elements may be configured to communicate with one another in any of a number of different manners including, for example, via a network 20. In this regard, the network 20 may be any of a number of different communication backbones or frameworks including a wired and/or wireless framework. Although FIG. 1 shows the devices or elements of the system 10 in communication with each other via the network 20, it should be understood that any one or more of the devices or elements could alternatively be directly in communication with each other.

In an exemplary embodiment, the stabilization sensor 14 may be configured to determine stabilization data regarding a platform. In other words, the stabilization sensor 14 may be configured to determine the orientation or attitude (or changes in the orientation or attitude) of a platform performing tracking on a particular object or point of interest. The tracking sensor 16 may be configured to provide tracking data for tracking a particular object or point of interest. In this regard, the tracking sensor 16 may, for example, capture video or image data regarding the particular object or point of interest or receive radio frequency emissions or returns from the particular object or point of interest. Meanwhile, the stabilized tracker 12 may be configured to provide stabilization for the tracking sensor 16 based on changes in orientation or attitude of the platform as determined at the stabilization sensor 14 and/or based on tracking information from the tracking sensor 16.

The stabilized tracker 12 may be any device or means embodied in either hardware, software, or a combination of hardware and software that is configured to provide stabilized tracking in accordance with embodiments of the present invention. In this regard, the stabilized tracker 12 may be configured to track a particular object or point of interest despite motion of the platform. The platform performing the tracking may be any vessel, vehicle, aircraft, or the like that is capable of motion while observing and/or tracking an object or point of interest. Thus, although an embodiment of the present invention will be described in greater detail below in reference to a waterborne vessel, it should be understood that the principles described herein also apply to vessels on land or in the air, while such vessels are capable of motion and/or tracking an object or point of interest. Accordingly, the stabilized tracker 12 may be configured to maintain track on the object or point of interest despite motion of the platform and/or motion of the object or point of interest.

In an exemplary embodiment, the stabilized tracker 12 may include or otherwise be in communication with a memory device 22 and/or a user interface 24. The user interface 24 may include devices and/or means for receiving user input and providing output to the user. For providing output to the user, the user interface 24 may include a display configured to display images, one or more speakers, and/or other devices capable of delivering mechanical, audible or visual output. The display may be, for example, a conventional LCD (liquid crystal display) or any other suitable display known in the art. For receiving input from the user, the user interface 24 may include, for example, a keyboard, keypad, function keys, mouse, track ball, joystick, scrolling device, touch screen, microphone and/or any other mechanism by which a user may interface with the system.

The stabilization sensor 14 may be any device or means, or collections of devices or means, configured to obtain attitude or orientation information relating to the platform. For example, a relatively simple embodiment of the stabilization sensor 14 could be a three axis Fiber Optic Gyro (FOG). In an exemplary embodiment, the stabilization sensor 14 may include one or more gyros or gimbals configured to provide orientation data indicative of changes in the attitude or orientation of the platform. In one embodiment, the stabilization sensor 14 may provide information defining motion of the platform with respect to rotation about at least one of a first axis, a second axis substantially perpendicular to the first axis, and a third axis substantially perpendicular to both the first axis and the second axis.

The tracking sensor 16 may be any sensor configured to observe and/or track an object or point of interest. As such, the tracking sensor 16 may include any of a number of different detection and ranging devices for detecting and/or tracking vessels, structures or aids to navigation. For example, the tracking sensor 16 may include a camera or a directional antenna and/or receiver, or a directional transceiver or transducer. In an exemplary embodiment, the tracking sensor 16 may be a camera configured to capture image data. The camera may be capable of obtaining image data over a field of view defined by a user via the user interface 24. Moreover, the user may utilize the user interface 24 to change a position of orientation of the camera in order to direct the field of view of the camera to capture image data related to an object or point of interest. As such, the tracking sensor 16 (e.g., the camera) may include a pan/tilt assembly 26 upon which the tracking sensor 16 may be mounted. The pan/tilt assembly 26 may include articulated mechanical linkages configured to enable movement of the tracking sensor 16 in at least two directions. For example, the pan/tilt assembly may enable movement of the camera in a rotation about a vertical axis with respect to a surface of the platform (e.g., a deck of the ship) in order to provide a panning function, and about a horizontal axis with respect to a surface of the platform in order to provide a tilting function. The pan/tilt assembly 26 may be configured to respond to signals provided by manual input by the user (e.g., by joystick input received at the user interface 24) and/or to signals generated by the stabilized tracker 12 by, for example, utilizing the signals received as track guidance signals driving a motor for repositioning the pan/tilt assembly 26.

In an embodiment in which the tracking sensor 16 is a camera device, the tracking sensor 16 may include or otherwise be in communication with a tracking element 27. Alternatively, the tracking element 27 could be embodied at the stabilized tracker 12. The tracking element 27 may be any device or means embodied in either hardware, software, or a combination of hardware and software that is configured to track an object or point of interest in an image or sequence of images. In this regard, the tracking element 27 may be configured to receive image data, for example, on a frame-by-frame basis, and in response to receipt of a user input identifying a particular object or point of interest, the tracking element 27 may define a window or portion of the image as a tracking window. Accordingly, the tracking element 27 may map pixels within the tracking window for each frame and compare a current frame to a subsequent frame with respect to the pixels therein. As such, if a particular object is defined within a tracking window and the object is centered within the tracking window in a first frame as determined, for example, by the grayscale values associated with each of the pixels, and the object is detected, based on pixel analysis, to have moved off center in a particular direction in a second frame, the tracking element 27 may be configured to provide a signal to the pan/tilt assembly 26 in order to move the camera in the particular direction by an amount that would restore the object to the center of the tracking window. Information related to object position determination relative to the tracking window may be considered tracking data. The tracking data may be used to track the position of an object or point of interest by “locking on” to the object such that the camera is controlled based on feedback or tracking data indicative of the motion of the object relative to the image captured based on a comparison of image frames. Tracking data may be used to maintain the camera directed toward the object in order to gather video surveillance data regarding the object, to maintain a gun or other weapon pointed toward or trained on the object, or for any other function that may be associated with tracking the object.

In situations in which the tracking sensor 16 is deployed on a platform that may experience ranges of motion sufficient to move the object outside the field of view of the camera, or at least sufficient to make keeping the object within the tracking window difficult, motion compensation for the tracking sensor 16 may be useful. Accordingly, the stabilized tracker 12 according to embodiments of the present invention may be capable of providing control inputs to the pan/tilt assembly 26 in order to compensate for both motion of the platform and the tracking data.

In an exemplary embodiment, the stabilized tracker 12 may include, be embodied as, or otherwise be in communication with a processing element 28. The processing element 28 may be configured to received stabilization data relating to changes in orientation or attitude of the platform and tracking data related to position and/or movement of an object or point of interest being tracked by the tracking sensor 16 and to provide stabilized track guidance to the pan/tilt assembly 26 in order to enable continued tracking of the object or point of interest by determining and compensating for the motion of the platform.

The processing element 28 may be embodied in a number of different ways. For example, the processing element 28 may be embodied as a processor, a coprocessor, a controller or various other processing means or devices including integrated circuits such as, for example, an ASIC (application specific integrated circuit). In an exemplary embodiment, the processing element 28 may be configured to execute instructions stored in the memory device 22 or otherwise accessible to the processing element 28. The memory device 22 may include, for example, volatile and/or non-volatile memory. The memory device 22 may be configured to store information, data, applications, instructions or the like for enabling the processing element 28 to carry out various functions in accordance with exemplary embodiments of the present invention. For example, the memory device 22 could be configured to buffer input data for processing by the processing element 28.

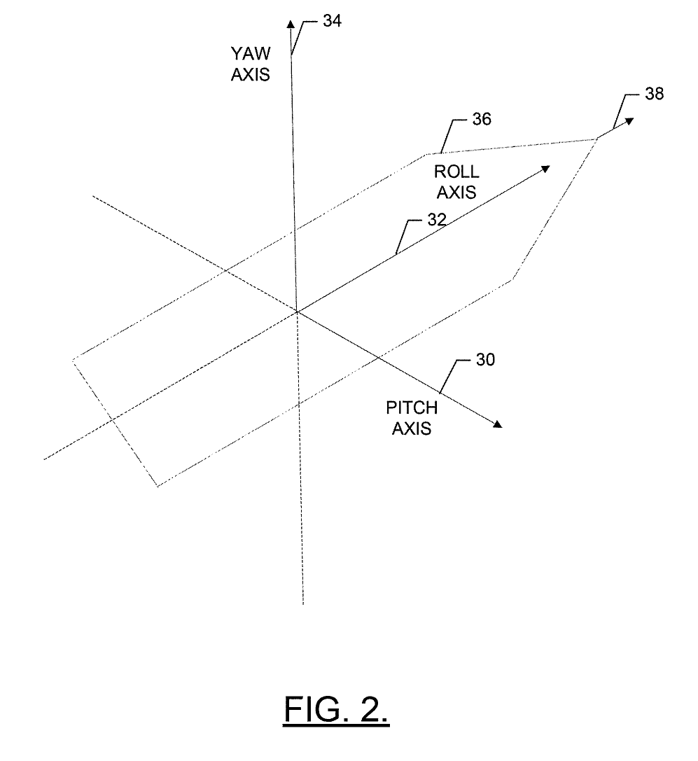

As indicated above, the stabilization sensor 14 may be configured to obtain attitude or orientation information relating to the motion of the platform relative to defined axes (e.g., the first, second and third axes). In an exemplary embodiment, the first axis may be called a pitch axis 30, the second axis may be called a roll axis 32, and the third axis may be called a yaw axis 34. FIG. 2 illustrates a diagram of pitch, roll and yaw axes referenced to a center of rotation of a platform 36. In the diagram of FIG. 2, the pitch axis 30 corresponds to an x axis, the yaw axis 34 corresponds to a y axis and the roll axis 32 corresponds to a z axis. As such, rotation with respect to the pitch axis 30 corresponds to a measurement of the pitch of the platform, the yaw axis 34 corresponds to a y axis and the roll axis 32 corresponds to a z axis. The x axis may correspond to the default port/starboard (left/right with respect to a ship's head) direction of a ship with port being negative and starboard being positive. In an exemplary embodiment, the z axis may correspond to the default fore/aft direction of the ship. In an exemplary embodiment, the z axis may be aligned by default with fore (i.e., the ship's head) corresponding to North and aft corresponding to South. The x axis may be aligned on an East/West orientation by default, with West corresponding to port and East corresponding to Starboard for a North heading ship. The y axis may correspond to a vertical axis of the ship with up being positive and down being negative. The origin of the axes may correspond to the center of rotation of the ship.

Accordingly, the stabilization sensor 14 may be configured to determine stabilization data related to changes in orientation or attitude of the platform 36. This stabilization data is typically referenced to the center of rotation of the platform 36. However, tracking devices such as the tracking sensor 16 may not be positioned at the center of rotation of the platform 36. To the contrary, the tracking sensor 16 may be disposed at a location displaced from the center of rotation by a distance in one or more of the x, y and z axes. Accordingly, due to the potential creation of various lever or moment arms by virtue of the displacement of the tracking sensor 16 along the axes, motion at the tracking sensor 16 may be different than motion of the platform 36 as measured relative to the center of rotation. In order to compensate for differences between platform motion and tracking device motion, the stabilized tracker 12 may be configured to translate measurements of motion made relative to the platform's center of rotation to corresponding motion at the tracking sensor 16.

In an embodiment where multiple tracking sensors are employed, the stabilized tracker 12 may receive a single input of stabilization data (which could be a stream of data, but in any case does not include more than one stream) measured relative to the platform's center of rotation and translate the single input into corresponding translated stabilization data corresponding to a translation of the motion of the platform 36 to each corresponding tracking sensor. The stabilized tracker 12 may then be configured to provide corresponding stabilized track guidance to the corresponding pan/tilt assembly of each of the tracking sensors. Accordingly, any need for stabilization sensors at each tracking sensor may be reduced due to the ability to provide independent stabilization to each of multiple sensors based on only measurement of platform motion rather than being based on multiple motion measurements corresponding to each of the multiple sensors.

Embodiments of the invention may provide for a reduction in the number of stabilization sensors that may be deployed on the same platform since more than one sensor or device may receive motion compensation stabilization input from a single source of stabilization data. Thus, procurement costs and life cycle costs for components may be reduced and reliability may be increased. In this regard, redundancy may be provided by including a second stabilization sensor or additional stabilization sensors. Since stabilization sensors are not mounted on individual pan/tilt assemblies, no feedback may be provided from a drive motor of the pan/tilt assembly to the stabilization sensors. The lack of individual stabilization sensors at each sensor or device also enables long term stabilization sensor drift to be compensated for at a minimal number of sources.

In order to provide adequate motion compensation, embodiments of the present invention are provided with sufficient update rates and latency. In one example, a system (using a simple commercial pan/tilt unit) according to an exemplary embodiment may be configured to maintain camera or other pointing device stabilization within a prescribed accuracy. Stabilization computations can also be provided for vertical and port/starboard moment arms and fore/aft moment arms measured from the center of rotation of the platform. Other performance specifications of one exemplary embodiment may include a target to boresight update rate, a target to boresight update latency, a minimum target contrast of a minimum target size and a maximum target size. However, embodiments may also employ other specifications.

Of note, the stabilized tracker 12 may also be utilized for stabilization of devices other than sensors that may be employed in connection with a tracking sensor. As such, the sensor may be aligned with the corresponding device. For example, spotlights, weapons, hailing units and other devices may also be stabilized to maintain a particular inertial pointing vector using embodiments of the present invention. In this regard, embodiments of the present invention may provide that the stabilized tracker 12 is configured to provide stabilized track guidance to the pan/tilt assembly 26 in order to maintain an inertial pointing vector aligned with a particular object or point of interest by compensating for platform motion and/or motion of the object or point of interest. The inertial pointing vector may be defined as a vector originating at a particular device (e.g., the tracking sensor 16) and pointing to a particular object or point of interest. In the context of a platform at sea, the inertial pointing vector may define a particular point at the surface of the water where an extension of the inertial pointing vector would intersect the surface of the water. As such, in an embodiment of the present invention, the stabilized tracker 12 may be configured to provide stabilized track guidance to the pan/tilt assembly 26 to maintain the inertial pointing vector oriented to the same intersection point despite motion of the platform. Furthermore, if an object or point of interest corresponding to the initial intersection point is in motion, the stabilized tracker 12 can be further configured to provide stabilized track guidance to the pan/tilt assembly 26 to maintain the inertial pointing vector trained on or pointing to the object or point of interest.

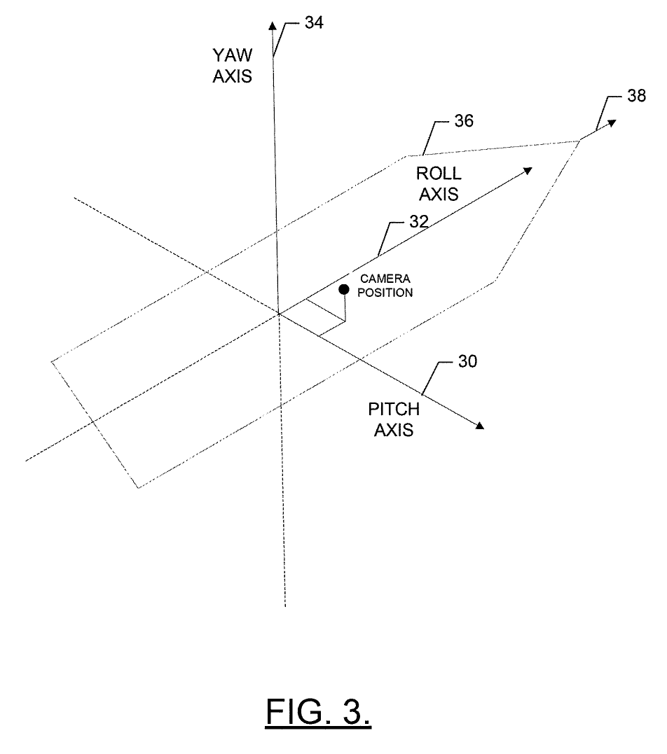

Operation of the stabilized tracker 12 according to an exemplary embodiment will now be described in reference to a platform tracking a particular object by referring to FIGS. 3-8. According to this exemplary embodiment, the tracking sensor may be a camera. FIG. 3 illustrates an example of inputting camera coordinates relative to the center of rotation of the platform 36 in order to enable platform motion translation according to an exemplary embodiment of the present invention. In this regard, initialization of the system 10 may be provided by informing the stabilized tracker 12 of the location of the camera in terms of a coordinate location in the coordinate frame of reference defined in FIG. 2. In other words, an x, y, z coordinate location defining the position of the camera may be associated with the camera. As shown in FIG. 3, a heading 38 of the platform 36 may initially be aligned with the roll axis 32 (e.g., the z axis). The camera may be assumed to have an initial default inertial pointing vector aligned with the heading 38 of the platform 36. After initialization of the system 10, roll, pitch and yaw data may be received from the stabilization sensor 14. The roll, pitch and yaw data may then be used to compensate for the motion of the platform 36 to maintain the inertial pointing vector in its initial orientation. Any order may be assigned to the compensation for roll, pitch and yaw but the order must correspond to the same order that has been used by the sensor to provide the attitude data. However, according to an exemplary embodiment, a standard order of rotation is yaw rotation performed first, followed by pitch and roll rotation, respectively.

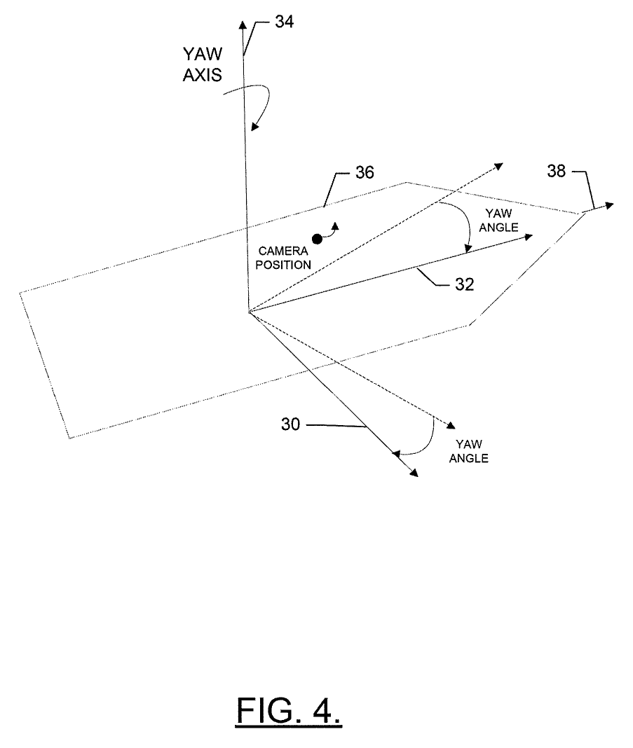

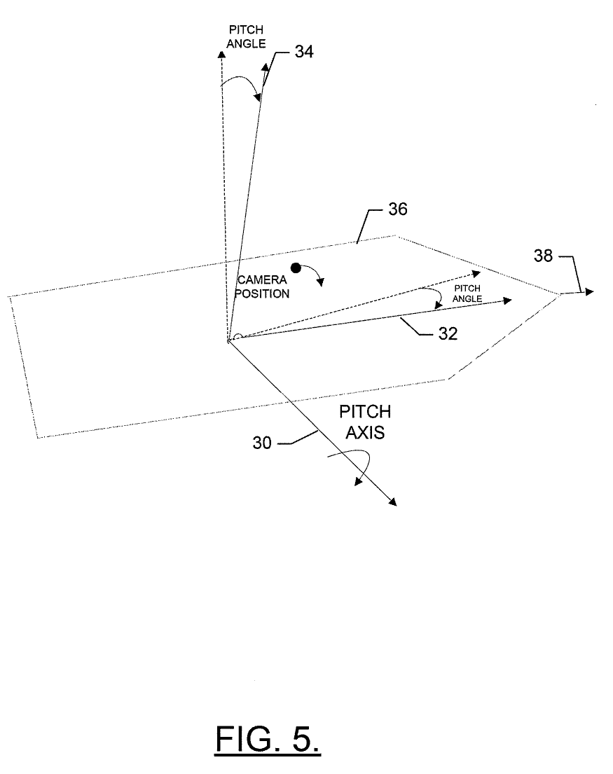

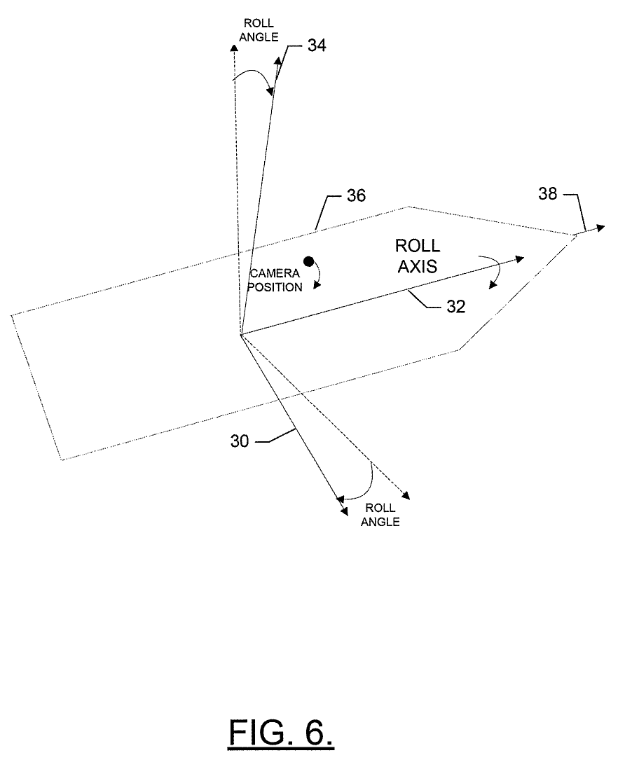

In this regard, FIG. 4 illustrates a diagram of a yaw rotation according to an exemplary embodiment of the present invention. As shown in FIG. 4, the heading 38 may be offset from the initial heading due to yaw of the platform 36. Accordingly, the pitch and roll axes 30 and 32 may be rotated about the yaw axis 34 by an amount corresponding to the measured yaw (e.g., a yaw angle 40) as translated to the camera. In other words, the stabilized tracker 12 may determine a yaw angle 40 that maintains the inertial pointing vector pointing to the same intersection point with the water by translating the platform yaw to a camera yaw to define an amount of yaw rotation to be used to compensate for yaw motion of the platform. FIGS. 5 and 6 illustrate camera pitch and roll rotations, respectively, which are compensated for in similar fashion. For example, as shown in FIG. 5, the yaw and roll axes 34 and 32 may be rotated about the pitch axis 30 by an amount corresponding to the measured pitch (e.g., a pitch angle 42) as translated to the camera. As shown in FIG. 6, the pitch and yaw axes 30 and 34 may be rotated about the roll axis 32 by an amount corresponding to the measured roll (e.g., a roll angle 44) as translated to the camera.

Rotation of the vectors may be performed by the stabilized tracker 12 using, for example quaternions or a 3×3 rotation matrix in order to compute rotation about an arbitrary axis in space. An exemplary embodiment will now be explained in the context of quaternions. Quaternions are a class of complex numbers with one real part and 3 imaginary parts, which are often expressed as having a real scalar (S) and an imaginary three dimensional (3D) vector (Vi=Xi, Yi, Zi) such as Q={S, Xi, Yi, Zi}. Alternatively, the quaternion may be expressed as Q={S, Vi}. To rotate a vector around an axis using quaternions, a rotation quaternion is determined where:

S=cosine(angle/2),
X=sine(angle/2),
Y=sine(angle/2), and
Z=sine(angle/2).
In order to determine a rotation pointing vector, the following is calculated:
Rotated pointing vector=((Q*pointing vector)*-Q), in which Q*pointing vector (p)={s,v}*p=(v·p), (s*p)+(v*p), where “·” represents a dot product and “*” represents a cross product. The result is a new quaternion.

To multiply two quaternions such as A and B, the following is performed:

S=A·s+B·s−(A·v·B·v)

V=((A·s*B·v)+(B·s*A·v))+(A·v*B·v).

The dot product of the two vectors results in a floating-point number that represents a magnitude of the difference in direction of the two vectors. To find the dot product of the two vectors (A and B), the following is performed:

A·B=A·x*Bx+Ay*B·y+A·z*B·z

The cross product of the two vectors is a vector perpendicular to both A and B. To find the cross product,

X=(A·y*B·z−B·y*A·z)

Y=(A·x*B·z−A·z*B·x)

Z=(A·y*B·x−A·x*B·y).

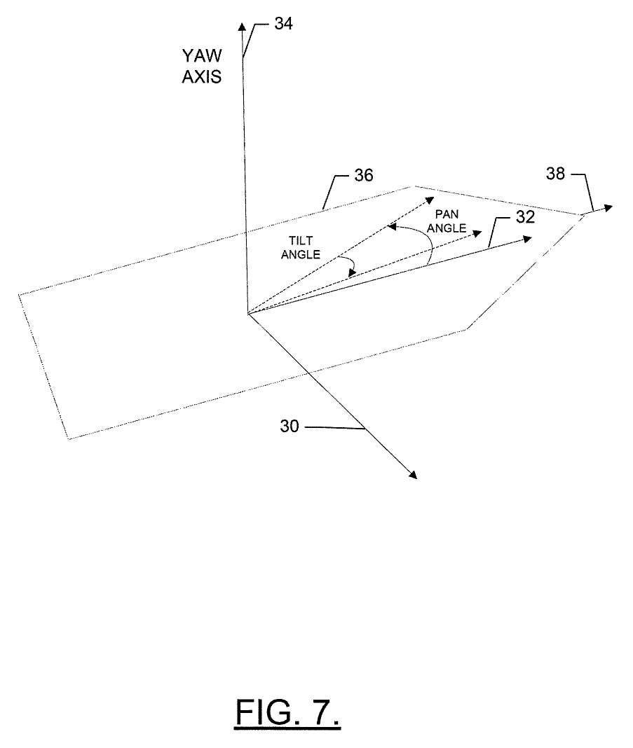

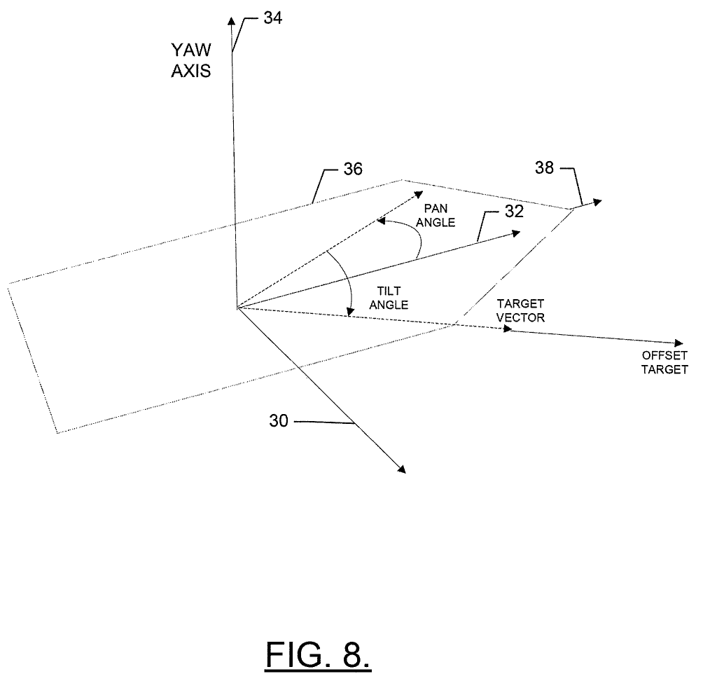

By performing the operations above at the stabilized tracker 12, motion of the platform 36 is translated to motion of the camera. However, in an exemplary embodiment, the pan/tilt assembly 26 may be configured to have two axes for motion rather than three. Thus, compensation measurements with respect to the platform's motion which have been determined with reference to a coordinate system having three axes may be converted (also at the stabilized tracker 12) to stabilized track guidance in terms of two axes (e.g., a pan axis and a tilt axis). Thus, after determining compensation measurements for the camera based on platform motion, initial location of the object (e.g., a target) may be found. In an exemplary embodiment, an operator may rotate the camera with manual commands using a joystick input until the object is within the field of view of the camera. A vector may be defined corresponding to the direction of the camera (e.g., a target vector). The target vector may initially be equal to the vector representing the z-axis of the platform 36. The vector may then be rotated by the stabilized tracker 12 by a pan angle around the yaw axis 34 of the platform 36. In order to determine the elevation or tilt of the camera, an axis for the camera to tilt with respect to is determined by the stabilized tracker 12 by taking the cross product of the yaw axis and the current target vector to achieve a unit vector that is perpendicular to both the yaw axis and the target vector. The unit vector is used as an axis to rotate the target vector around by the tilt angle as shown in FIG. 7. As shown in FIG. 7, after adjusting the camera by the pan angle and the tilt angle, the camera points according to the determined target vector. By scaling the vector, the stabilized tracker 12 may determine the target's location in space. The correct scale is derived from the ratio of the y value of the target vector and the camera location's y value. The two vertical distances defined by these y values form a multiplier that may be used by the stabilized tracker 12 to scale the target vector. Each of the target vector's coordinates may be multiplied by the stabilized tracker 12 to result in a location of the target as compared to the camera, which defines an offset target. If the camera's location is added to the offset target, the target's position in space as measured relative to the center of the platform 36 is defined if it is assumed that the target is at the surface of the water, thereby defining the inertial pointing vector. FIG. 8 illustrates the offset target according to an exemplary embodiment.

In order to stabilize the camera, new angles may be repeatedly computed by the stabilized tracker 12 for the pan/tilt assembly as described above in order to account for motion of the platform 36. In this regard, vectors are initialized to their original positions and rotated to their new positions as described above in reference to FIGS. 3-6. The normal to the new yaw axis and new offset target may then be determined. To determine the new offset target, the camera's new center is subtracted from the target's coordinates. Next a vector that is perpendicular to both the yaw axis and the offset target vector is determined. The vector is in the plane in which the camera will be rotated. The pan angle is determined by taking the dot product of the pitch axis and the vector. The cosine of the pan angle is the dot product divided by the length of the normal. Thus, the pan angle may be determined as being equal to: arccosine((normal·pitch axis)/normal length). The length of a 3D vector is equal to the square root of (x²+y²+z²). The tilt angle may be found in similar fashion. The distance from the camera to the target may be used in this regard. The dot product of the offset target and the yaw axis may be computed and the arccosine of the dot product may be divided by the distance to provide the angle between the offset target and the yaw axis. If the angle is greater than the tilt angle by 90 degrees, 90 degrees may be subtracted (π/2 radians) to find the actual tilt angle. The new pan and tilt angles may be used to provide stabilized track guidance to the pan/tilt assembly 26. Target tracking as described above may be added in addition to the above described stabilization measures in order to provide stabilized track with respect to the object.

In an exemplary embodiment, if an input device for manual camera repositioning, such as a joystick, is not centered on a target, the target vector is adjusted by rotating the target vector around the yaw axis by an amount indicated by the joystick position. The target vector is then rotated around the tilt axis by an amount indicated by the joystick and the target location is computed by scaling the new target vector by the camera's y value over the target vector's y value.

In operation, due to movement of the platform and time elapsing prior to computation and communication of stabilized track guidance quick changes in pan/tilt angles may result in a jerky control of the camera. Accordingly, the stabilized track guidance according to embodiments of the present invention may also be provided with rate information to define a rate of motion of the camera when moving to compensate for platform motion and/or object motion. In this regard, a difference between the inertial pointing vector determined and a current position of the camera may be determined and divided by an elapsed time to obtain a rate for camera motion. In an exemplary embodiment, rate determination may be derived to include an integral and a proportional part. The integral part may be determined by accumulating an error value (e.g., the difference between initial camera position and the current inertial pointing vector) multiplied by an integral gain value and the change in time. As such, the integral value may be an initial integral value plus the integral gain value times the change in time and the error value. The rate could then be calculated as a proportional gain multiplied by a sum of the error value and the integral value.

In an exemplary embodiment, outputs from the stabilization sensor 14 may be combined by the stabilized tracker 12 with heading information provided, for example, from a gyrocompass of the platform 36. Accordingly, for example, compass heading information may be sampled once per second and subtracted from the last sampled heading to produce a heading error. The heading error may then be used to determine a correction factor. A small fraction of the correction factor may be added to the angular rate from the sensor before being multiplied by the change in time to provide a new value that can be added to the old heading to come up with the current heading. Additionally, in order to remove any bias that may be associated with the stabilization sensor 14, the bias may be calculated as a fraction of the error value to determine a correction factor that can be applied to the old heading as described above.

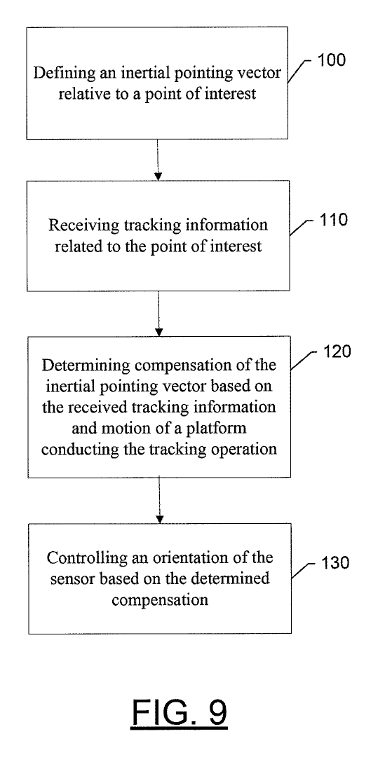

FIG. 9 is a flowchart of a method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a tracking system and executed by a processor in the tracking system. The computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

A method for providing stabilization during a tracking operation according to an exemplary embodiment may include defining an inertial pointing vector relative to a point of interest at operation 100. At operation 110, tracking information related to the point of interest may be received. The tracking information may be video information. Compensation of the inertial pointing vector may be determined in real-time based on the received tracking information and motion of a platform conducting the tracking operation at operation 120. In an exemplary embodiment, the method may further include controlling an orientation of the sensor based on the determined compensation at operation 130. Controlling the orientation of the sensor may include controlling a pan/tilt assembly that positions the sensor. Controlling the orientation of the sensor may include converting a three axis compensation value to a two axis guidance value for driving the orientation of the sensor. The rate of application of guidance value may be controlled based on a difference between the inertial pointing vector and the current orientation of the sensor.

In an exemplary embodiment, operation 120 may include translating motion of the platform, as measured relative to a center of rotation of the platform, to motion of a sensor associated with receiving the tracking information to compensate the inertial pointing vector for the motion of the sensor based on the motion of the platform. In another exemplary embodiment, operation 120 may include receiving information defining motion of the platform with respect to rotation about at least one of a first axis, a second axis substantially perpendicular to the first axis, and a third axis substantially perpendicular to both the first axis and the second axis. In this regard, determining the compensation of the inertial pointing vector may include determining a camera adjustment amount for keeping an object corresponding to the point of interest in an image within a particular portion of a frame of the video information based on a position of the object in a prior frame. In an alternative embodiment, receiving tracking information may include receiving radio frequency information and determining the compensation of the inertial pointing vector and may include determining an adjustment of a device tracking an object corresponding to the point of interest based on the received radio frequency information.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for providing stabilization during a tracking operation, the method comprising:
defining an inertial pointing vector relative to a point of interest;
receiving tracking information related to the point of interest; and
determining compensation of the inertial pointing vector based on the received tracking information and motion of a platform conducting the tracking operation.

2. The method of claim 1, wherein determining the compensation of the inertial pointing vector comprises translating motion of the platform, as measured relative to a center of rotation of the platform, to motion of a sensor associated with receiving the tracking information to compensate the inertial pointing vector for the motion of the sensor based on the motion of the platform.

3. The method of claim 1, further comprising controlling an orientation of the sensor based on the determined compensation.

4. The method of claim 1, wherein determining the compensation of the inertial pointing vector comprises receiving information defining motion of the platform with respect to rotation about at least one of a first axis, a second axis substantially perpendicular to the first axis, and a third axis substantially perpendicular to both the first axis and the second axis.

5. The method of claim 1, wherein receiving tracking information comprises receiving video information and wherein determining the compensation of the inertial pointing vector comprises determining a camera adjustment amount for keeping an object corresponding to the point of interest in an image within a particular portion of a frame of the video information based on a position of the object in a prior frame.

6. A computer program product for providing stabilization during a tracking operation, the computer program product comprising at least one computer-readable storage medium having computer-readable program code portions stored therein, the computer-readable program code portions comprising:
a first executable portion for defining an inertial pointing vector relative to a point of interest;
a second executable portion for receiving tracking information related to the point of interest; and
a third executable portion for determining compensation of the inertial pointing vector based on the received tracking information and motion of a platform conducting the tracking operation.

7. The computer program product of claim 6, wherein the third executable portion includes instructions for translating motion of the platform, as measured relative to a center of rotation of the platform, to motion of a sensor associated with receiving the tracking information to compensate the inertial pointing vector for the motion of the sensor based on the motion of the platform.

8. The computer program product of claim 6, further comprising a fourth executable portion for controlling an orientation of the sensor based on the determined compensation.

9. The computer program product of claim 8, wherein the fourth executable portion includes instructions for controlling a pan/tilt assembly that positions the sensor.

10. The computer program product of claim 8, wherein the fourth executable portion includes instructions for converting a three axis compensation value to a two axis guidance value for driving the orientation of the sensor.

11. The computer program product of claim 10, wherein the fourth executable portion includes instructions for controlling a rate of application of the guidance value based on a difference between the compensated inertial pointing vector and a current orientation of the sensor.

12. The computer program product of claim 6, wherein the third executable portion includes instructions for receiving information defining motion of the platform with respect to rotation about at least one of a first axis, a second axis substantially perpendicular to the first axis, and a third axis substantially perpendicular to both the first axis and the second axis.

13. The computer program product of claim 6, wherein the second executable portion includes instructions for receiving video information.

14. The computer program product of claim 13, wherein the third executable portion includes instructions for determining a camera adjustment amount for keeping an object corresponding to the point of interest in an image within a particular portion of a frame of the video information based on a position of the object in a prior frame.

15. The computer program product of claim 6, wherein the second executable portion includes instructions for receiving radio frequency information and wherein the third executable portion includes instructions for determining an adjustment of a device tracking an object corresponding to the point of interest based on the received radio frequency information.

16. An apparatus for providing stabilization during a tracking operation, the apparatus including a processing element configured to:
define an inertial pointing vector relative to a point of interest;
receive tracking information related to the point of interest; and
determine compensation of the inertial pointing vector based on the received tracking information and motion of a platform conducting the tracking operation.

17. The apparatus of claim 16, wherein the processing element is further configured to translate motion of the platform, as measured relative to a center of rotation of the platform, to motion of a sensor associated with receiving the tracking information to compensate the inertial pointing vector for the motion of the sensor based on the motion of the platform.

18. The apparatus of claim 16, wherein the processing element is further configured to control an orientation of the sensor based on the determined compensation.

19. The apparatus of claim 18, wherein the processing element is further configured to control a pan/tilt assembly that positions the sensor.

20. The apparatus of claim 18, wherein the processing element is further configured to convert three axis compensation values to two axis guidance values for driving the orientation of the sensor.

21. The apparatus of claim 20, wherein the processing element is further configured to control a rate of application of the guidance values based on a difference between the compensated inertial pointing vector and a current orientation of the sensor.

22. The apparatus of claim 16, wherein the processing element is further configured to receive information defining motion of the platform with respect to rotation about at least one of a first axis, a second axis substantially perpendicular to the first axis, and a third axis substantially perpendicular to both the first axis and the second axis.

23. The apparatus of claim 16, wherein the processing element is further configured to receive video information.

24. The apparatus of claim 23, wherein the processing element is further configured to determine a camera adjustment amount for keeping an object corresponding to the point of interest in an image within a particular portion of a frame of the video information based on a position of the object in a prior frame.

25. An apparatus for providing stabilization during a tracking operation, the apparatus including a processing element configured to:
define an inertial pointing vector relative to a point of interest;
receive tracking information from a camera related to the point of interest; and
determine compensation of the inertial pointing vector based on the received tracking information and motion of a waterborne vessel conducting the tracking operation.
